(19) United States
(12) Patent Application Publication
(10) Pub. No.: US 2020/0048097 A1
(43) Pub. Date: Feb. 13, 2020

(54) METHOD FOR PRODUCING GRAPHITE FILM

(71) Applicant: KANEKA CORPORATION, Osaka-shi, Osaka (JP)

(72) Inventors: Motoaki KOBAYASHI, Settsu-shi (JP); Masahiro KOJIMA, Settsu-shi (JP); Yasushi NISHIKAWA, Settsu-shi (JP)

(73) Assignee: KANEKA Corporation, Osaka-shi, Osaka (JP)

(21) Appl. No.: 16/339,399

(22) PCT Filed: Oct. 12, 2017
(86) PCT No.: PCT/JP2017/037008

§ 371 Date: Apr. 4, 2019

(30) Foreign Application Priority Data
Oct. 14, 2016 (JP) 2016-202795

(51) Int. Cl. C01B 32/205

(52) U.S. Cl. CPC C01B 32/205; C01B 2204/24

(57) ABSTRACT

A method of producing a graphite film has an excellent appearance and excellent thermal diffusivity. A graphite film production method includes the steps of: preparing a polyimide film having a heating loss rate X of 0.13% to 10%, which heating loss rate X is represented by: heating loss rate X=(b−a)/a . . . Formula (1); and graphitizing the polyimide film by subjecting the polyimide film to a heat treatment. Where (i) a represents a mass of the polyimide film after the polyimide film is heated at 400° C. for 15 minutes and (ii) b represents a mass of the polyimide film after the polyimide film is heated at 150° C. for 15 minutes.

### TECHNICAL FIELD

The present invention relates to a method of producing a graphite film which has an excellent appearance and excellent thermal diffusivity.

### BACKGROUND ART

Graphite films are used as heat dissipating films of electronic devices, precision devices, and the like, and as heat spreader materials. A graphite film contains carbon having a layered structure. This causes in-plane thermal conductivity of the graphite film to be extremely high, and causes the graphite film to have excellent thermal diffusivity and small mass. In addition, a graphite film is a material having a high electrical conduction property and excellent flexibility. A graphite film has therefore been a preferred a material for the application described above.

Among various methods for producing a graphite film, a method of graphitizing a polymer is simple. The use of the method of graphitizing a polymer makes it possible to obtain a graphite film having an excellent thermal conduction property and an excellent electrical conduction property. The method is therefore more suitable for the application described above. Known examples of the method encompass a method such as that disclosed in Patent Literature 1, in which a graphite film is obtained by subjecting a polymeric film to a heat treatment in an inert atmosphere, under reduced pressure, or the like. Examples of the polymeric film encompass polyoxadiazole, polyimide, polyphenylene vinylene, polybenzimidazole, polybenzoxazole, polythiazole, and polyamide. Examples of gas used for the inert atmosphere encompass argon and helium.

As a method of graphitizing a polyimide film by subjecting the polyimide film to a high-temperature heat treatment, Patent Literature 2 discloses a method of producing a graphite film, including the step of subjecting a polyimide film having a birefringence of not less than 0.12 to a heat treatment at a temperature not less than 2400° C. This method focuses on molecular orientation of a polyimide film, and is configured so that a greater tendency with which polyimide molecules are in-plane oriented makes it possible to (i) keep a maximum temperature for the graphitization lower and (ii) cause a period of the heat treatment to be shorter. In addition, Patent Literature 2 discloses using, as a polyimide film having excellent molecular orientation, a polyimide film having a small linear expansion coefficient, and discloses that such a polyimide film preferably has a composition that (i) p-phenylene(trimellitic acid monoester dianhydride) or pyromellitic dianhydride is used as a dianhydride component and (ii) 4,4′-oxydianiline or p-phenylenediamine is used as a diamine component.

There have been various efforts to produce a graphite film having excellent properties such as electrical conductivity and thermal conductivity. For example, the following methods are known: (i) a method in which, as disclosed in Patent Literature 3, a long polyimide film is wound around a core so as to be carbonized; and (ii) a method in which, as disclosed in Patent Literature 4, carbonaceous film is obtained by applying pressure against a polymeric film in a thickness direction while the polymeric film is being continuously conveyed with use of a continuous carbonizing device, and then a resulting product is graphitized by being subjected to a high-temperature heat treatment.

Meanwhile, the most typical example of how a polyimide film is used is a substrate of a flexible printed circuit board (hereinafter referred to as “FPC”). The most important issue of a polyimide film used as an FPC is dimensional stability. If the dimensions of the polyimide film considerably change after the polyimide film is processed into an FPC, then the circuit unfortunately shifts from where components are supposed to be mounted by design, so that it unfortunately becomes impossible to connect the mounted components to the FPC.

It is considered that a polyimide film to be used for an FPC preferably has a small thermal expansion coefficient, a small coefficient of moisture expansion, and a small thermal shrinkage rate, in order to solve such a problem. For example, Patent Literature 5 discloses a polyimide film having a thermal shrinkage rate of not more than 0.10% under conditions of 200° C. for 1 hour.

In addition, as a method of productively producing, as a substrate for FPC, a polyimide film that satisfies mechanical characteristics such as tensile strength, Patent Literature 6 discloses a method of continuously heating a polyamic acid composition on a support at two temperature levels or more. A heating loss rate of a polyimide film obtained in such a manner is small.

### CITATION LIST

### Patent Literature

[Patent Literature 1]

Japanese Patent Application Publication, Tokukaisho, No. 61-275116

[Patent Literature 2]

International Publication, No, 2005/023713

[Patent Literature 3]

International Publication, No. 2010/029761

[Patent Literature 4]

International Publication, No. 2014/046187

[Patent Literature 5]

Japanese Patent Application Publication, Tokukai, No. 2007-196670

[Patent Literature 6]

Japanese Patent Application Publication, Tokukai, No. 2002-283369

### SUMMARY OF INVENTION

### Technical Problem

There have been cases where, when a polyimide film is subjected to a high-temperature heat treatment, a graphite having an excellent appearance unfortunately may not be obtained without properly selecting conditions of the heat treatment, depending on the kind of the polyimide film. In addition, there have been cases where an obtained graphite film had a thermal diffusivity which was unfortunately inferior to a required level. In particular, there have been cases where the conditions of a heat treatment for obtaining a graphite film having good quality were limited when a polyimide film having excellent molecular orientation was subjected to the heat treatment.

While various efforts have been made for methods of graphitizing a polyimide film by subjecting the polyimide film to a high-temperature heat treatment, many of the methods were focused on the conditions of the heat treatment. There have not been sufficient researches focusing on a polyimide film which is a raw material. For example, there have not been sufficient researches focusing on what polyimide film should be selected to obtain, as a result of subjecting the polyimide film to a heat treatment, a graphite film having an excellent appearance and excellent thermal diffusivity.

### Solution to Problem

As a result of diligent study, the inventors of the present invention found that a graphite film having an excellent appearance and excellent thermal diffusivity can be obtained by employing a novel production method in which a certain polyimide film is used. The inventors of the present invention thus arrived at the present invention. An embodiment of the present invention encompasses the following features.

1) A method of producing a graphite film, including the steps of: preparing a polyimide film having a heating loss rate X of 0.13% to 10%, which heating loss rate X is represented by Formula (1) below; and graphitizing the polyimide film by subjecting the polyimide film to a heat treatment,

Heating loss rate X=(b−a)/a Formula (1)

where (i) a represents a mass of the polyimide film after the polyimide film is heated at 400° C. for 15 minutes and (ii) b represents a mass of the polyimide film after the polyimide film is heated at 150° C. for 15 minutes.

2) A method of producing a graphite film, including the steps of: preparing a polyimide film having a thermal shrinkage rate of riot less than 0.30% after being heated at 400° C. for minutes; and graphitizing the polyimide film by subjecting the polyimide film to a heat treatment.

3) The method described in 1) or 2), in which the polyimide film contains: a dianhydride containing a pyromellitic dianhydride; and diamine containing at least one of 4,4′-oxydianiline and paraphenylenediamine.

4) The method described in 3), in which: the polyimide film contains 4,4′-oxydianiline and paraphenylenediamine in an amount of not less than 90% relative to an entirety of the diamine; and a ratio between an amount of the 4,4′-oxydianiline and an amount of the paraphenylenediamine are contained is 100:0 to 70:30.)

5) The method described in 3), in which; the polyimide film contains 4,4′-oxydianiline and paraphenylenediamine in an amount of not less than 90% relative to an entirety of the diamine; and a ratio between an amount of the 4,4′-oxydianiline and an amount of the paraphenylenediamine are contained is 100;0 to 80:20.

6) The method described in any one of 1) through 5), in which: the step of graphitizing the polyimide film includes the steps of carbonizing the polyimide film so as to obtain a carbonized film and further heating the carbonized film at a high temperature; and a heating rate during the carbonizing is not more than 5° C./min.

### Advantageous Effects of Invention

With a graphite film production method in accordance with an aspect of the present invention, it is possible to obtain a graphite film having an excellent appearance and excellent thermal diffusivity.

### Description of Embodiments

(1. Method of Producing Graphite Film)

According to an aspect of the present invention, a graphite film production method includes the step of preparing a polyimide film having a heating loss rate X of 0.13% to 10% (any range of “X to Y” herein means “X or more and Y or less), which heating loss rate X is represented by the following Formula (1):

Heating loss rate X=(b−a)/a Formula (1)

where (i) a represents a mass of the polyimide film after the polyimide film is heated at 400° C. for 15 minutes and (ii) b represents a mass of the polyimide film after the polyimide film is heated at 150° C. for 15 minutes.

The heating loss rate is measured as follows. The following are prepared: (i) a polyimide film which has been cut into a 5 cm×5 cm piece and (ii) an aluminum container having an opening which is large enough for the polyimide film to pass through. The polyimide film is placed in the aluminum container, and then the aluminum container is placed in an oven at 150° C. 15 minutes later, the aluminum container is taken out. Then, the polyimide film is cooled to room temperature, and then the mass of the polyimide film is measured with use of an electronic balance. This mass is regarded as the mass of the polyimide film after the polyimide film is heated at 150° C. for 15 minutes. Next, the oven is heated to 400° C., and then the aluminum container, in which the polyimide film is placed, is placed in the oven. 15 minutes later, the aluminum container is taken out. Then, the polyimide film is cooled to room temperature, and then the mass of the polyimide film is measured with use of an electronic balance. This mass is regarded as the mass of the polyimide film after the polyimide film is heated at 400° C. for 15 minutes.

In another aspect of the present invention, the graphite film production method includes the step of preparing a polyimide film having a thermal shrinkage rate of not less than 0.30%.

The thermal shrinkage rate is measured as follows. A polyimide film which has been cut into a 200 mm×200 mm piece is prepared, and then the dimensions of the polyimide film in a machine direction (MD) (i.e., direction in which a material is conveyed during film production) and in a transverse direction (TD) (i.e., direction in which the width of the film extends so as to be orthogonal to the machine direction (MD)) are measured. Next, the polyimide film is heated at 400° C. for 15 minutes, and then cooled to room temperature. Then, the dimensions in the machine direction (MD) and in the transverse direction (TD) are measured again. Respective change rates in the machine direction (MD) and in the transverse direction (TD) are calculated, and an average of the change rates is regarded as a thermal shrinkage rate of the film.

A polyimide film is used as a raw material of a graphite film. A polyimide film is typically used for, for example, an FPC substrate. Various researches have been conducted in order to satisfy dimensional stability, insulating characteristics, mechanical characteristics, and the like which are required for a polyimide film to be used for an FPC substrate. Examples of a polyimide film which has excellent dimensional stability and which is intended for an FPC encompass those widely used in this technical field, such as (i) Apical (registered trademark) manufactured by Kaneka Corporation, (ii) Kapton (registered trademark) manufactured by DuPont-Toray Co., Ltd., and (iii) Upilex (registered trademark) manufactured by Ube Industries, Ltd. Many polyimide films intended for FPC are utilized as raw materials of graphite films. Therefore, many researches for obtaining graphite having good quality concern the conditions of carbonization and of a subsequent high-temperature heat treatment.

Meanwhile, as the results of studying a polyimide film itself, for example, it is known that graphitization of a polyimide film, which has a birefringence of not less than 0.12 and in which polyimide is in-plane oriented, allows for graphitization at a relatively low temperature and in a relatively short period of time, in comparison with cases where other polymeric films are used.

With use of a polyimide film exhibiting the excellent orientation, the inventors of the present invention prepared graphite films while changing various conditions such as a heating temperature, a temperature-rise profile, and a production form including a sheet-fed form and a continuous form. As a result, it was found that (i) a heat treatment of a polyimide film having excellent orientation certainly leads to a graphite film having good quality and (ii) a poor appearance and/or insufficient thermal diffusivity may occur, depending on the conditions of a heat treatment of the polyimide film having excellent orientation.

In order to attain the object, the inventors of the present invention also focused on characteristics of a polyimide film, and conducted a study on production of a polyimide film itself. The inventors of the present invention prepared various polyimide films, attempted graphitizing the polyimide films, and studied whether or not a process window of a heat treatment may be made broad. Specifically, the inventors of the present invention not only changed the composition of a polyimide film, but also graphitized various films obtained by changing various conditions in: (i) adjustment of a gel film obtained in an intermediate step of the production of the film and (ii) a step in which the gel film is further heated at a high temperature so as to produce a polyimide film.

As a result, it was found that (1) a graphite film having superior quality is obtained if a polyimide film ultimately obtained has a volatile component to a certain extent and (2) a graphite film having superior quality is obtained if the polyimide film has a thermal shrinkage rate to a certain extent, which thermal shrinkage rate falls within a specific range.

In particular, while excellent dimensional stability and an excellent mechanical characteristic are essential for a polyimide film which is intended for an FPC, the inventors of the present invention found that such characteristics are not necessary in producing a graphite film, but it is rather desirable that a polyimide film to be graphitized have a volatile component and a thermal shrinkage rate.

Based on this knowledge, the inventors of the present invention found, as a method of producing a graphite film having good quality, a method in which (i) a polyimide film having a certain heating loss rate is prepared and then (ii) the polyimide film is graphitized. Therefore, a polyimide film used in an aspect of the present invention has a heating loss rate of 0.13% to 10%.

The inventors of the present invention conducted further study, and considered that, depending on the conditions of a heat treatment during graphitization of a polyimide film having excellent orientation, a poor appearance and/or insufficient thermal diffusivity may occur because heat during the graphitization causes orientation to advance, so that generated gas is contained in the polyimide film without escaping, and ultimately destroys a layer. It was presumed that a problem may occur as a result of heating a polyimide film in such a manner as to advance the orientation in graphite, whereas graphite having good quality is obtained by increasing a heating rate during graphitization so as to be able to shorten a period of a heat treatment because, in such a case, the orientation advances somewhat slowly. Therefore, it was considered that in a case where a polyimide film in which a volatile component is remaining to a certain extent is prepared and graphitized, a residual volatile component evaporates first during the heat treatment, so that the polyimide film is carbonized while a type of pathway for a gas component is being made. Specifically, it was considered that in a case where the gas component passes through an escape pathway made in advance by the evaporation of the volatile component, a poor appearance is prevented and graphite having good quality can be obtained. Therefore, the inventors of the present invention prepared polyimide films through changing production conditions in various ways, graphitized the polyimide films, and examined the appearance and thermal diffusivity. As a result, it was experimentally confirmed that a heating loss rate of not less than 0.13% tends to indicate that the appearance and the thermal diffusivity are improved. According to an aspect of the present invention, a lower limit value of the heating loss rate is set as a result of the experimental confirmation as described above.

Meanwhile, an upper limit value of the heating loss rate is not particularly limited from the viewpoint of an appearance and thermal diffusivity of a graphite film to be obtained. However, if the amount of volatile component contained in a polyimide film is excessively large, then problems may occur such as volatile matters contaminating a furnace or being ignited. Therefore, the upper limit value of the heating loss rate is preferably not more than 10%.

Hence, according to an aspect of the present invention, the heating loss rate of the polyimide film is preferably 0.15% to 10%, more preferably 0.20% to 5%, and even still more preferably 1.5% to 5%.

The inventors of the present invention also found, as a method of producing a graphite film having good quality, a method in which (i) a polyimide film having a certain thermal shrinkage rate is prepared and then (ii) the polyimide film is graphitized. Therefore, the inventors of the present invention prepared polyimide films through changing production conditions in various ways, graphitized the polyimide films, and examined the appearance and thermal diffusivity. As a result, it was experimentally confirmed that a thermal shrinkage rate of not less than 0.30% tends to indicate that the appearance and the thermal diffusivity are improved. According to an aspect of the present invention, a lower limit value of the thermal shrinkage rate is set as a result of the experimental confirmation as described above. It is unclear why a graphite film having good quality is obtained by using a polyimide film having a thermal shrinkage rate of a certain value or more. The inventors of the present invention presume that this is because during the carbonization, the polyimide film shrinks to a somewhat large extent in a surface direction so as to disturb the molecular orientation, so that the polyimide film is carbonized while a type of pathway for a gas component is being made.

Hence, according to an aspect of the present invention, the thermal shrinkage rate of the polyimide film is preferably not less than 0.30%, more preferably not less than 0.50%, and still more preferably not less than 0.80%.

Meanwhile, an upper limit value of the heating loss rate is not particularly limited from the viewpoint of an appearance and thermal diffusivity of a graphite film to be obtained. Note, however, that 5% is a suitable value to be able to control during an ordinary process of producing polyimide.

According to an aspect of the present invention, a graphite film production method preferably includes the step of: preparing a polyimide film having a heating loss rate X of 0.13% to 10% and a thermal shrinkage rate of not less than 0.30%, which heating loss rate X is represented by the Formula (1) below; and graphitizing the polyimide film by subjecting the polyimide film to a heat treatment,

Heating loss rate X=(b−a)/a Formula (1)

where (i) a represents a mass of the polyimide film after the polyimide film is heated at 400° C. for 15 minutes and (ii) b represents a mass of the polyimide film after the polyimide film is heated at 150° C. for 15 minutes.

In regard to the thickness of a polyimide film, generally a lesser thickness of the polyimide film results in a graphite film having a superior appearance. Meanwhile, if the thickness of the polyimide film is large, then the amount of gas generated during the carbonization becomes large. This tends to make it difficult to obtain a graphite film having a good appearance and excellent thermal diffusivity. This is true even in a case where the heating rate during the carbonization is adjusted as appropriate. However, in an aspect of the present invention, a generated gas easily escapes during production of a graphite film as a result of producing the graphite film with use of a polyimide film having a certain heating loss rate or a certain thermal shrinkage rate as described above. This advantageously allows a graphite film having good thickness to be obtained with use of a thick polyimide film. According to an aspect of the present invention, therefore, the polyimide film has a thickness of preferably not less than 25 μm, more preferably not less than 50 μm, and still more preferably not less than 60 μm.

(2. Polyimide Film)

An example of a method of producing a polyimide film used in an aspect of the present invention will be described below.

The polyimide film used in an aspect of the present invention is produced from a solution of a polyamic acid which is a precursor of polyimide. A polyamic acid is ordinarily produced by (i) dissolving, in an organic solvent, at least one aromatic dianhydride and at least one aromatic diamine in substantially equimolar quantities so as to obtain a polyamic acid organic solvent solution and (ii) stirring the polyamic acid organic solvent solution at a controlled temperature until the aromatic dianhydride and the aromatic diamine are completely polymerized. Such a polyamic acid solution is obtained ordinarily at a concentration of 15% by mass to 25% by mass. A polyamic acid solution at a concentration falling within the above range can have a suitable molecular weight and a suitable solution viscosity.

Then, polyimide is obtained by imidization of the polyamic acid thus obtained. According to an aspect of the present invention, imidization of a polyamic acid (i.e., production of polyimide) can be carried out by a thermal cure method or a chemical cure method. A chemical cure method is suitable for imidization according to an aspect of the present invention. A chemical cure method is a method of causing a dehydrator and a cyclizing catalyst to work in a polyamic acid organic solvent solution, the dehydrator being typified by an acid anhydride such as an acetic anhydride, and the cyclizing catalyst being typified by tertiary amines such as 3-picoline, isoquinoline, and pyridine. The chemical cure method can be used in combination with a thermal cure method. The reaction conditions of the imidization can change depending on, for example, the kind of polyamic acid and the thickness of the film.

A material used for the polyamic acid, which is a precursor of polyimide, will be described below.

According to an aspect of the present invention, examples of a suitable acid anhydride used in production of the polyamic acid encompass pyromellitic dianhydride, 2,3,6,7-naphthalene tetracarboxylic dianhydride, 3,3′,4,4′-biphenyl tetracarboxylic dianhydride, 1,2,5,6-naphthalene tetracarboxylic dianhydride, 2,2′,3,3′-biphenyl tetracarboxylic dianhydride, 3,3′,4,4′-benzophenone tetracarboxylic dianhydride, 2,2-bis(3,4-dicarboxyphenyl)propane dianhydride, 3,4,9,10-perylene tetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride,oxydiphthalic dianhydride, bis(3,4-dicarboxyphenyl)sulfone dianhydride, p-phenylenebis(trimellitic acid monoester anhydride), ethylenebis(trimellitic acid monoester anhydride), bisphenol A bis(trimellitic acid monoester anhydride), and analogues of these acid anhydrides. Preferably, these acid anhydrides can be used alone or a mixture in which these acid anhydrides are mixed at any ratio can be used.

According to an aspect of the present invention, examples of suitable diamine used in production of the polyamic acid encompass 4,4′-diaminodiphenyl propane, 4,4′-diaminodiphenylmethane, benzidine, 3,3′-dichlorobenzidine, 4,4′-diaminodiphenyl sulfide, 3,3′ diaminodiphenyl sulfone, 4,4′-diaminodiphenyl sulfone, 4,4′-oxydianiline, 3,3′-oxydianiline, 3,4′-oxydianiline, 1,5-diaminonaphthalene, 4,4′-diaminodiphenyldiethyl silane, 4,4′-diaminodiphenyl silane, 4,4′-diaminodiphenyl ethyl phosphine oxide, 4,4′-diaminodiphenyl N-methylamine, 4,4′-diaminodiphenyl N-phenylamine, 1,4-diaminobenzene(p-phenylenediamine 1,3-diaminobenzene, 1,2-diaminobenzene, and analogues of these diamines. Preferably, these diamines can be used alone, or a mixture in which these diamines are mixed at any ratio can be used.

Among the acid anhydrides above, examples of dianhydrides which bring about molecules that are easily oriented in production of a film encompass pyromellitic dianhydride (PMDA), 3,3′,4,4′-benzophenone tetracarboxylic dianhydride, 3,3′,4,4′-biphenyl tetracarboxylic dianhydride, and p-phenylenebis(trimellitic acid monoester anhydride). Therefore, in a case of a polyimide film in which any of these dianhydrides is used, ordinarily, conditions of heating in the step of graphitization may be limited. However, in a case where the polyimide film having a certain heating, loss rate or a certain thermal shrinkage rate in an aspect of the present invention is used, it is possible to obtain a graphite film having good quality without selecting the conditions of heating in the step of graphitization. Specifically, a graphite film having good physical properties can be advantageously obtained not only in a case where a heating rate is high in the step of graphitizing a polyimide film, particularly the step of carbonizing the polyimide film, but also in a case where the heating rate is slow.

In regard to the diamine component, graphite having good quality can be advantageously obtained in a case where at least one of 4,4′-oxydianiline (ODA) and p-phenylenediamine (PDA) is used. Using these diamine components in combination tends to bring about molecules that are easily oriented in production of a film. Therefore, ordinarily, conditions of heating in the step of graphitization may be limited. However, in a case where the polyimide film having a certain heating loss rate or a certain thermal shrinkage rate in an aspect of the present invention is used, it is possible to obtain a graphite film having good quality without selecting the conditions of heating in the step of graphitization. Specifically, a graphite film having good physical properties can be advantageously obtained not only in a case where a heating rate is high in the step of graphitizing a polyimide film, particularly the step of carbonizing the polyimide film, but also in a case where the heating rate is slow. In a case where the diamine components are used in combination, in particular, it is preferable that (i) 4,4′-oxydianilne and paraphenylenediamine are contained in an amount of not less than 90% relative to the. entirety of the diamine and (ii) a ratio between the 4,4′-oxydianiline and the paraphenylenediamine is preferably 100:0 to 70:30, and more preferably 100:0 to 80:20.

A solvent for synthesizing a polyamic acid is preferably an amide solvent. Especially, N,N-dimethylacetamide, N,N-dimethylformamide, and N-methyl-2-pyrrolidone, for example, are preferably used.

According to an aspect of the present invention, examples of the dehydrator used in the imidization of the polyamic acid by a chemical cure method encompass aliphatic acid anhydride, aromatic acid anhydride, N,N-dialkylcarbodiimide, lower aliphatic halide, halogenated lower aliphatic halide, halogenated lower fatty acid anhydride, aryl phosphonic acid dihalide, thienyl halide, and a mixture of two or more of these dehydrators Among these, aliphatic anhydrides such as acetic anhydride, propionic anhydride, and butyric anhydride and a mixture of two or more of these aliphatic anhydrides can be preferably used. The dehydrator can be used in an amount of 1 part by mass to 80 parts by mass, preferably 5 parts by mass to 70 parts by mass, and more preferably 10 parts by mass to 50 parts by mass, relative to 100 parts by mass of the polyamic acid organic solvent solution.

For making imidization of the polyamic acid effective, it is preferable to use the dehydrator and the cyclizing catalyst simultaneously. Examples of the cyclizing catalyst encompass aliphatic tertiary amines, aromatic tertiary amines, and heterocyclic tertiary amines. Among these cyclizing catalysts, those selected from heterocyclic tertiary amines are particularly preferable. Specifically, for example, quinoline, isoquinoline, β-picoline, or pyridine, and a mixture of these can be preferably used. The catalyst can be used in an amount of 0.1 parts by mass to 30 parts by mass, preferably 0.5 parts by mass to 20 parts by mass, and more preferably 1 part by mass to 15 parts by mass, relative to 100 parts by mass of the polyamic acid organic solution. If the amount of the catalyst is excessively small, then an imidization rate tends to be below a suitable range. If the amount of the catalyst is excessively large, then curing becomes too rapid, so that it is difficult to cast the gel film onto a support.

Imidization of the polyamic acid with use of the dehydrator and the cyclizing catalyst is preferable in production of a polyimide film as described above. Note that chemical imidization with use of a dehydrator and a cyclizing catalyst tends to cause the orientation in the polyimide film, which is to be ultimately obtained, to advance easily. Therefore, a film obtained by the chemical imidization brings about the advantageous effect of the present invention more remarkably.

A concrete example of the method of producing the polyimide will be described below. Note, however, that the polyimide production method in accordance with an embodiment of the present invention is of course not limited to the method described below.

A dehydrator and a cyclizing catalyst arc mixed at a low temperature in a polyamic acid organic solvent solution. Then, the polyamic acid organic solvent solution is cast onto a support such as a glass plate, an aluminum foil, a metal endless belt, or a metal drum, so as to become a resin film. The resin film is heated on the support so that the polyamic acid organic solvent solution is partially cured and/or dried. For partially curing and/or drying the polyamic acid organic solvent solution, hot air, far-infrared radiant heat, or the like can be provided, or the support can be heated. In addition, it is possible to combine (i) a method of providing hot air, far-infrared radiant heat, or the like and (ii) a method of heating the support. By the heating, the cast resin film is made into a semi-cured film (so-called “gel film”) which is self-supporting, so as to be peeled from the support. This gel film is produced in an intermediate stage of the process of curing the polyamic acid so as to produce the polyimide (i.e., the gel film is partially imidized to be self-supporting), and contains a residual volatile component such as a solvent. The imidization rate of the gel film is calculated by use of an infrared ray spectroscopy method according to the following formula:

Imidization rate (%)=(A/B)×100/(C/D)

where

A represents an absorption peak height at 1370 cm-1 of a gel film,

B represents an absorption peak height at 1500 cm-1 of a gel film,

C represents an absorption peak height at 1370 cm-1 of a polyimide film, and

D represents an absorption peak height at 1500 cm-1 of a polyimide film.

This value is not less than 50%, preferably not less than 70%, and more preferably not less than 80%. The “partially curing and/or drying the polyamic acid organic solvent solution partial imidization)” described above is preferably carried out in these ranges. If the imidization rate falls below these ranges, then a problem may occur such as difficulty in peeling the gel film from the support.

In addition, a residual volatile component rate of the gel film is calculated by the following expression

(E-F)×100/F(%)

where

E represents the mass of the gel film and

F represents the mass of the gel film after the gel film is heated at 450° C. for 20 minutes,

This value is 50% to 300%, preferably 80% to 250%, and more preferably 100% to 200%. A film having a residual volatile component rate failing within these ranges is suitable. A gel film having a residual volatile component rate above these ranges is poor in self-supporting, so that the gel film may be stretched or broken when conveyed to a heating furnace. This prevents stable production.

Note that setting a residual volatile component rate of the gel film to a higher value tends to cause the thermal shrinkage rate of the polyimide film to be higher.

Changing the amount of dehydrator, the amount of cyclizing catalyst, and the drying temperature on the support makes is possible to control the heating loss rate and the thermal shrinkage rate. Setting the drying temperature on the support to a lower temperature allows the heating loss rate or the thermal shrinkage rate to be higher, although the heating loss rate and the thermal shrinkage rate also depend on a temperature of the subsequent heating furnace.

Then, the gel is further heated so as to remove (dry) the residual solvent, and the curing (imidization) of the gel film is completed in so doing, for the purpose of prevent shrinkage of the gel film during the drying and the curing, the gel film is conveyed to the heating furnace while end parts of the gel film are held to a tenter frame with use of pins, tenter clips, or the like.

By changing the conveying conditions in the heating furnace in various ways, it is possible to adjust the heating loss rate. A heating furnace suitably used in production of the polyimide film is (i) a hot blast furnace in which the film is heated by blowing hot air at the whole film from a side facing a top surface of the film, from a side facing a bottom surface of the film, or from both of the sides or (ii) a far-infrared furnace including a far-infrared ray generating device which fires the film by irradiating the film with far-infrared rays. In the heating step, it is preferable to fire the film by increasing the temperature in stages. For this reason, in production of the polyimide film, it is preferable to use (i) several hot blast furnaces connected so as to fire the film in stages, (ii) several far-infrared furnaces connected so as to fire the film in stages, or (iii) several heating furnaces including a hot blast furnace(s) and a far-infrared furnace(s) which are connected so as to fire the film in stages.

The heating temperature, which is first applied to the film when the film is conveyed into the furnace, is preferably decided in view of (i) the kind of the polyimide film and (ii) a volatilization temperature of the solvent. In a case where a polyimide film to be used for an FPC substrate is produced, ordinarily, the heating temperature is preferably 60° C. to 300° C. In production of the polyimide film used in an aspect of the present invention, it is possible to control the heating loss rate and the thermal shrinkage rate by heating a gel film at a temperature lower than a temperature which is ordinarily set.

While an initial temperature is preferably not higher than 270° C., the heating loss rate and the thermal shrinkage rate can be controlled by setting a temperature(s) in the subsequent furnace(s) to a relatively low temperature.

From the viewpoint of lowering the heating loss rate of a polyimide film to be ultimately obtained, a gel film is typically fired while several furnaces including a hot blast furnace(s) and a far-infrared furnace(s) are connected. In particular, with a far-infrared furnace, it is possible to volatilize, through thermal motion, solvents which have entered molecules. A far-infrared furnace is therefore preferably used in ordinary production of a polyimide film. This is because solvents remaining in a polyimide film cause such a problem that while it is attempted to dispose the polyimide film and a copper foil together with use of an adhesive, the polyimide film and the copper foil may be peeled from each other. Therefore, in a case where a polyimide film intended for an FPC is produced, a gel film is fired while several furnaces including a hot blast furnace(s) and a far-infrared furnace(s) are connected.

The use of a far-infrared furnace is thus the simplest method of lowering the heating loss rate. In a case where a polyimide film intended for an FPC is produced, a far-infrared heater is typically set to a temperature not lower than 500° C. and preferably not lower than 600° C. However, the polyimide film used in an embodiment of the present invention has a heating loss rate which is somewhat high. Therefore, the polyimide film is preferably produced while (i) no far-infrared furnace is used or (ii) the temperature of the far-infrared furnace is set to a relatively low temperature. In a case where a far-infrared furnace is used, the temperature of the heater is set to a temperature which is preferably not higher than 400° C. and more preferably not higher than 350° C.

The heating loss rate can also be controlled by changing a line speed. A faster line speed tends to result in a higher heating loss rate. A slower line speed tends to result in a lower heating loss rate. Therefore, respective temperatures of the connected furnaces for ultimately obtaining a polyimide film having an intended heating loss rate are set in view of the relationship between the temperatures and the line speed.

A tension to be applied in a machine direction (MD) to a gel film while the gel film is being conveyed in a furnace is obtained by calculating a tension (load) applied per m of the film, and is preferably 1 kgf/m to 50 kgf/m, and more preferably 1 kgf/m to 30 kgf/m. A tension of not more than kgf/m makes it difficult to stably convey a film, so that it tends to become difficult to hold the film and stably produce a film.

The tension applied to the gel film being conveyed to a furnace can be adjusted with use of a tension generating device employing any of various methods. Examples of the methods encompass (i) a method in which a loading roller is used to apply tension to a gel film, (ii) a method in which a rotation speed of a roller is adjusted so as to change tension, and (iii) a method in which two nip rollers are used to sandwich a gel film so as to control tension.

In addition, the thermal shrinkage rate can also be made higher by adjusting the above conditions of the heating furnace. For example, the thermal shrinkage rate is higher in a case where the tension applied in the machine direction (MD) to a gel film being conveyed is larger. For example, the tension is preferably not less than 5 kgf/m.

The heating loss rate and the thermal shrinkage rate of the polyimide film can be easily measured by methods such as those described above. Therefore, an ultimate film production conditions can be set as appropriate by examining whether or not the film has an intended heating loss rate or an intended thermal shrinkage rate, while changing the conditions of producing a polyimide film, particularly the following conditions are changed in various ways: (i) a drying temperature on a support, (ii) the amount of residual volatile component of a gel film, (iii) the temperature of a heating furnace, (iv) the tension applied while the film is being conveyed, and (v) the line speed. According to an aspect of the present invention, a polyimide film having a heating loss rate of 0.13% to 10% is thus prepared, and is graphitized. This allows a graphite film having an excellent appearance and excellent thermal diffusivity to be provided. According to another aspect of the present invention, a polyimide film having a thermal shrinkage rate of not less than 0.30% is prepared, and is graphitized. This allows a graphite film having an excellent appearance and excellent thermal diffusivity to be provided.

(3. Graphitizing Step)

According to an aspect of the present invention, a graphitizing step preferably includes the steps of: carbonizing a polyimide film so as to obtain a carbonized film; and further heating the carbonized film at a high temperature. According to an aspect of the present invention, the carbonizing step in the graphitizing step is preferably carried out at a heating rate of not more than 5° C./min.

According to an aspect of the present invention, the carbonizing step is carried out so that the polyimide film obtained as described above is preheated under reduced pressure or in nitrogen gas, and is then carbonized. A temperature during the preheating is not particularly limited, provided that the polyimide film is properly carbonized. The preheating is preferably carried out so that a maximum temperature is 700° C. to 1600° C.

The heating rate in the carbonizing step can be, for example, 0.1° C./min. to 1.00° C./min. From the viewpoint of obtaining graphite :having good quality, it is desirable to use a polyimide film having large in-plane orientation and carbonize the polyimide film at a high heating rate, preferably not less than 15° C./min., and more preferably not less than 20° C./min. According to an embodiment of the present invention, however, a graphite film having good quality is supposedly obtained even in a case where (i) a polyimide film used is produced by selecting a composition, an imidization method, and the like which cause polyimide to be easily oriented as described above and (ii) the orientation in the polyimide film advances due to a heat treatment. This is because, even in such a case, a pathway for gas is generated as described above. Therefore, the heating rate can be a relatively low heating rate of not more than 10° C./min., can be a low heating rate of not more than 5° C./min. With an aspect of the present invention, it is possible to obtain a graphite film having good quality even in a case of such a low heating rate. It can therefore be said that a graphite film production method in accordance with an aspect of the present invention is suitable not only for a method in which a polyimide film is continuously carbonized but also for a sheet-fed method in which it is difficult to strictly set heating conditions such as a heating rate.

According to an aspect of the present invention, the step of further heating, at a high temperature, the carbonized film obtained in the carbonizing step can be achieved by setting the carbonized film in an ultra-high-temperature furnace and then graphitizing the carbonized film. The step of further heating the carbonized film at a high temperature is carried out under reduced pressure or in an inert gas, and preferably in an inert gas. Although the inert gas is not limited to any particular one, the inert gas is preferably argon, and more preferably a gas obtained by adding a small amount of helium to argon. The heat treatment is carried out so that a maximum temperature is not lower than 2000° C., more preferably not lower than 2400° C., and still more preferably not lower than 2600° C.

Higher heat treatment temperatures enable conversion into graphite having superior quality. From an economical viewpoint, however, the conversion into graphite having good quality is preferably achieved at as low a temperature as possible. For ultra-high temperature of not lower than 2500° C. to be obtained, heating is ordinarily carried out by passing an electric current directly through a graphite heater and utilizing the Joule heat generated.

With the graphite film production method in accordance with an aspect of the present invention, a graphite film having good quality can be thus obtained without selecting the composition of a polyimide film which is a starting material. Therefore, an aspect of the present invention provides a graphite film production method in which heating conditions during the graphitization are not limited and which is therefore also suitable for sheet-fed production.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss the present invention in further detail through Examples. Note, however that the present invention is not limited to these Examples.

(Method of Measuring Heating Loss Rate of Polyimide Film)

The heating loss rate was measured as follows. The following are prepared: (i) a polyimide film which was cut into a 5 cm×5 cm piece and (ii) an aluminum container having an opening which was large enough for the polyimide film to pass through. The polyimide film was placed in the aluminum container, and then the aluminum container was placed in an oven at 150° C. 15 minutes later, the aluminum container was taken out. Then, the polyimide film was cooled to room temperature, and then the mass of the polyimide film was measured with use of an electronic balance. This mass was regarded as the mass of the polyimide film after the polyimide film was heated at 150° C. for 15 minutes. Next, the oven was heated to 400° C., and then the aluminum container, in which the polyimide film was placed, was placed in the oven, 15 minutes later, the aluminum container was taken out. Then, the polyimide film was cooled to room temperature, and then the mass of the polyimide film was measured with use of an electronic balance. This mass was regarded as the mass of the polyimide film after the polyimide film was heated at 400° C. for 15 minutes.

The heating loss rate X is represented by the following Formula (1):

Heating loss rate X=(b−a)/a Formula (1)

where (i) a represents a mass of the polyimide film after the polyimide film is heated at 400° C. for 15 minutes and (ii) b represents a mass of the polyimide film after the polyimide film is heated at 150° C. for 15 minutes.

(Method of Measuring Thermal Shrinkage Rate of Polyimide Film)

The thermal shrinkage rate was measured as follows. A polyimide film which was cut into a 200 mm×200 mm piece was prepared, and then the dimensions of the polyimide film in a machine direction (MD) and in a transverse direction (TD) were measured. Next, the polyimide film was heated at 400° C. for 15 minutes, and then cooled to room temperature. Then, the dimensions in the machine direction (MD) and in the transverse direction (TD) were measured again. Respective change rates in the machine direction (MD) and in the transverse direction (TD) were calculated, and an average of the change rates was regarded as a thermal shrinkage rate of the film.

(Appearance of Graphite Film)

An appearance of a graphite film was evaluated as follows. The number of seeds and surface-peeled parts, which were visually observable within a 5 cm×5 cm area, were counted, and the appearance was considered as “Excellent” if the number was 0, “Good” if the number was 1 to 5, “Unsatisfactory” if the number was 6 to 20, and “Poor” if the number was 21 or more.

(Thermal Diffusivity of Graphite Film)

The thermal diffusivity of the graphite film was measured as follows. That is, a sample having a size of 4 mm×40 mm was cut out from a center part of the graphite film. A thermal diffusivity of the sample was then measured in an atmosphere of 23° C. and at 10 Hz with use of a thermal diffusivity measurement device (“Laser Pit” manufactured by ULVAC-RIKO, which employs the light alternating-current method.

### Example 1

<Production of Polyimide Film>

A polyamic acid solution was synthesized by (i) adding 4,4′-oxydianiline (ODA) at a proportion of 75 mol %, paraphenylenediamine (PDA) at a proportion of 25 mol %, and pyromellitic dianhydride (PMDA) at a proportion of 100 mol %, to N,N-dimethylformamide (DMF) which is an organic solvent for polymerization and (ii) stirring a resulting product so as to polymerize the resulting product. In so doing, the polyamic acid solution was synthesized so that a solid content concentration in the polyamic acid solution to be obtained would be 18.5% by mass.

Then, acetic anhydride and isoquinoline were added to the polyamic acid solution so that 2.0 equivalents of the acetic anhydride and 1.0 equivalent of the isoquinoline were added with respect to the equivalent of the amic acid. Then, a resulting product was cast onto an endless belt. Then, the resulting product was subjected to hot air drying in a range of 120±10° C. for 4 minutes. This produced a gel film (polyimide precursor film) which was self-supporting. This gel film was removed from the endless belt, and then both of widthwise end parts of the gel film were fixed to a pin sheet that continuously conveys the gel film.

This gel film was fired in stages (in a first heating furnace (hot air) at 250° C., in a second heating furnace (hot air) at 300° C., in a third heating furnace (hot air) at 340° C., and in a fourth heating furnace (far-infrared) at 400° C.) so that imidization of the gel film advanced. This produced a polyimide film having a thickness of 50 μm. In so doing, the heating loss rate was 0.24%, and the thermal shrinkage rate was 0.58%.

<Production of Graphite Film>

The polyimide film thus prepared was cut into a 5 cm×5 cm piece. Then the piece was sandwiched between graphite plates, and then subjected to carbonization with use of an electric furnace in which a temperature was raised to 1400° C. at a rate of 25° C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 0 MPa with use of a single-plate press. This produced a graphite film (having a thickness of 25 μm).

### Example 2

A polyimide film and a graphite film were produced as in Example 1 except that the conditions under which the polyimide film was dried were changed as follows.

Then, acetic anhydride and isoquinoline were added to a polyamic acid solution so that 2.0 equivalents of the acetic anhydride and 1.0 equivalent of the isoquinoline were added with respect to the equivalent of the amic acid. Then, a resulting product was cast onto an endless belt. Then, the resulting product was subjected to hot air drying in a range of 120±10° C. for 4 minutes. This produced a gel film (polyimide precursor film) which was self-supporting. This gel film was removed from the endless belt, and then both of widthwise end parts of the gel film were fixed to a pin sheet that continuously conveys the gel film.

This gel film was fired in stages (in a first heating furnace at 250° C., in a second heating furnace at 300° C., and in a third heating furnace at 450° C.) so that imidization of the gel film advanced. This produced a polyimide film having a thickness of 50 μm. In so doing, the heating loss rate was 1.48%, and the thermal shrinkage rate was 0.75%. Then, the graphite film (having a thickness of 25 μm) was obtained as in Example 1.

### Example 3

A polyimide film and a graphite film were produced as in Example 1 except that the conditions under which the polyimide film was dried were changed as follows.

Then, acetic anhydride and isoquinoline were added to a polyamic acid solution so that 2.0 equivalents of the acetic anhydride and 1.0 equivalent of the isoquinoline were added with respect to the equivalent of the amic acid. Then, a resulting product was cast onto an endless belt. Then, the resulting product was subjected to hot air drying in a range of 120±10° C. for 4 minutes. This produced a gel film (polyimide precursor film) which was self-supporting. This gel film was removed from the endless belt, and then both of widthwise end parts of the gel film were fixed to a pin sheet that continuously conveys the gel film.

This gel film was fired in stages (in a first heating furnace at 250° C., in a second heating furnace at 300° C., in a third heating furnace at 340° C., and in a fourth heating furnace at 350° C.) so that imidization of the gel film advanced. This produced a polyimide film having a thickness of 50 μm. In so doing, the heating loss rate was 3.09%, and the thermal shrinkage rate was 0.90%. Then, the graphite film (having a thickness of 25 μm) was obtained as in Example 1.

### Example 4

A polyimide film and a graphite film were produced as in Example 1 except that the conditions under which the polyimide film was dried were changed as follows.

Then, acetic anhydride and isoquinoline were added to a polyamic acid solution so that 2.0 equivalents of the acetic anhydride and 1.0 equivalent of the isoquinoline were added with respect to the equivalent of the amic acid. Then, a resulting product was cast onto an endless belt. Then, the resulting product was subjected to hot air drying in a range of 120±10° C. for 4 minutes. This produced a gel film (polyimide precursor film) which was self-supporting. This gel film was removed from the endless belt, and then both of widthwise end parts of the gel film were fixed to a pin sheet that continuously conveys the gel film.

This gel film was fired in stages (in a first heating furnace at 270° C., in a second heating furnace at 340° C., in a third heating furnace at 370° C., and in a fourth heating furnace at 400° C.) so that imidization of the gel film advanced. This produced a polyimide film having a thickness of 50 μm. In so doing, the heating loss rate was 0.15%, and the thermal shrinkage rate was 0.50%. Then, the graphite film (having a thickness of 25 μm) was obtained as in Example 1.

### Comparative Example 1

A polyimide film and a graphite film were produced as in Example 1 except that the conditions under which the polyimide film was dried were changed as follows.

Then, acetic anhydride and isoquinoline were added to a polyamic acid solution so that 2.0 equivalents of the acetic anhydride and 1.0 equivalent of the isoquinoline were added with respect to the equivalent of the amic acid. Then, a resulting product was cast onto an endless belt. Then, the resulting product was subjected to hot air drying in a range of 120±10° C. for 4 minutes. This produced a gel film (polyimide precursor film) which was self-supporting. This gel film was removed from the endless belt, and then both of widthwise end parts of the gel film were fixed to a pin sheet that continuously conveys the gel film.

This gel film was fired in stages (in a first heating furnace at 250° C., in a second heating furnace at 300° C., in a third heating furnace at 340° C., and in a fourth heating furnace at 480° C.) so that imidization of the gel film advanced. This produced a polyimide film having a thickness of 50 μm. In so doing, the heating loss rate was 0.05%, and the thermal shrinkage rate was 0,10%, Then, the graphite film (having a thickness of 25 μm) was obtained as in Example 1.

### Comparative Example 2

A polyimide film and a graphite film were produced as in Example 1 except that the conditions under which the polyimide film was dried were changed as follows.

Then, acetic anhydride and isoquinoline were added to a polyamic acid solution so that 2.0 equivalents of the acetic anhydride and 1.0 equivalent of the isoquinoline were added with respect to the equivalent of the auric acid. Then, a resulting product was cast onto an endless belt. Then, the resulting product was subjected to hot air drying in a range of 120±10° C. for 4 minutes. This produced a gel film (polyimide precursor film) which was self-supporting. This gel film was removed from the endless belt, and then both of widthwise end parts of the gel film were fixed to a pin sheet that continuously conveys the gel film.

This gel film was fired in stages (in a first heating furnace at 250° C., in a second heating furnace at 300° C., in a third heating furnace at 340° C., and in a fourth heating furnace at 450° C.) so that imidization of the gel film advanced. This produced a polyimide film having a thickness of 50 μm. In so doing, the heating loss rate was 0.12%, and the thermal shrinkage rate was 0.28%. Then, the graphite film (having a thickness of 25 μm) was obtained as in Example 1.

### Example 5

A polyimide film having a thickness of 38 μm was obtained as in Example 3. In so doing, the heating loss rate was 2.42%, and the thermal shrinkage rate was 0.83%. Then, the graphite film (having a thickness of 18 μm) was obtained as in Example 1.

### Example 6

A polyimide film having a thickness of 52 μm was obtained as in Example 3. In so doing, the heating loss rate was 3.76%, and the thermal shrinkage rate was 0.95%. Then, the graphite film (having a thickness of 32 μm) was obtained as in Example 1.

### Example 7

A polyimide film as produced as in Example 1 except that (i) 4,4′-oxydianiline (ODA) at a proportion of 100 mol % and pyromellitic dianhydride (PMDA) at a proportion of 100 mol % were used as monomers and (ii) the conditions under which the polyimide film was dried were changed as follows.

Then, acetic anhydride and isoquinoline were added to a polyamic acid solution so that 2.0 equivalents of the acetic anhydride and 1.0 equivalent of the isoquinoline were added with respect to the equivalent of the amic acid. Then, a resulting product was cast onto an endless belt. Then, the resulting product was subjected to hot air drying in a range of 120±10° C. for 4 minutes. This produced a gel film (polyimide precursor film) which was self-supporting. This gel film was removed from the endless belt, and then both of widthwise end parts of the gel film were fixed to a pin sheet that continuously conveys the gel film.

This gel film was fired in stages a first heating furnace at 250° C., in a second heating furnace at 300° C., in a third heating furnace at 340° C., and in a fourth heating furnace at 350° C.) so that imidization of the gel film advanced. This produced a polyimide film having a thickness of 50 μm. In so doing, the heating loss rate was 2.66%, and the thermal shrinkage rate was 1.05%.

In addition, a graphite film as produced as follows. The polyimide film was cut into a 5 cm×5 cm piece. Then the piece was sandwiched between graphite plates, and then subjected to carbonization with use of an electric furnace in which a temperature was raised to 1400° C. at a rate of 5° C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 25 μm).

### Comparative Example 3

A polyimide film was produced as in Example 7 except that the conditions under which the polyimide film was dried were changed as follows.

Then, acetic anhydride and isoquinoline were added to a polyamic acid solution so that 2.0 equivalents of the acetic anhydride and 1.0 equivalent of the isoquinoline were added with respect to the equivalent of the amic acid. Then, a resulting product was cast onto an endless belt. Then, the resulting product was subjected to hot air drying in a range of 120±10° C. for 4 minutes. This produced a gel film (polyimide precursor film) which was self-supporting. This gel film was removed from the endless belt, and then both of widthwise end parts of the gel film were fixed to a pin sheet that continuously conveys the gel film.

This gel film was fired in stages a first heating furnace at 250° C., in a second heating furnace at 300° C., in a third heating furnace at 340° C., and in a fourth heating furnace at 480° C.) so that imidization of the gel film advanced. This produced a polyimide film having a thickness of 50 μm. In so doing, the heating loss rate was 0.05%, and the thermal shrinkage rate was 0.20%.

In addition, a graphite film was produced as follows. The polyimide film was cut into a 5 cm×5 cm piece. Then the piece was sandwiched between graphite plates, and then subjected to carbonization with use of an electric furnace in which a temperature was raised to 1400° C. at a rate of 5° C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 25 μm).

### Example 8

A polyimide film and a graphite film were produced as in Example 1 except that the carbonization conditions in the production of the graphite film were changed as follows.

The polyimide film was cut into a 5 cm×5 cm piece. Then the piece was sandwiched between graphite plates, and then subjected to carbonization with use of an electric furnace in which a temperature was raised to 1400° C. at a rate of 5°C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 25 μm).

### Example 9

A polyimide film and a graphite film were produced as in Example 2 except that the carbonization conditions in the production of the graphite film were changed as follows.

The polyimide film was cut into a 5 cm×5 cm piece. Then the piece was sandwiched between graphite plates, and then subjected to carbonization with use of an electric furnace in which a temperature was raised to 1400° C. at a rate of 5° C./min. in nitrogen. A carbonized film obtained by the carbonization was sandwiched between graphite plates, and then subjected to graphitization with use of a graphitization furnace in which a temperature was raised to 2300° C. at a heating rate of 1° C./min. in argon. Then, a resulting product was compressed at a pressure of 20 MPa with use of a single-plate press. This produced a graphite film (having a thickness of 25 μm).

### Example 10

A polyimide film and a graphite film were produced as in Example 3 except that the carbonization conditions in the production of the graphite film were changed as follows.

The polyimide film was cut into a 5 cm×5 cm piece. Then the piece was sandwiched between graphite plates, and then subjected to carbonization with use of an electric furnace in which a temperature was raised to 1400° C. at a rate of 5° C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 25 μm).

### Example 11

A polyimide film and a graphite film were produced as in Example 4 except that the carbonization conditions in the production of the graphite film were changed as follows

The polyimide film was cut into a 5 cm×5 cm piece. Then the piece was sandwiched between graphite plates, and then subjected to carbonization with use of an electric furnace in which a temperature was raised to 1400° C. at a rate of 5° C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 25 μm).

### Comparative Example 4

A polyimide film and a graphite film were produced as in Comparative Example 1 except that the carbonization conditions in the production of the graphite film were changed as follows.

The polyimide film was cut into a 5 cm×5 cm piece. Then the piece was sandwiched between graphite plates, and then subjected to carbonization with use of an electric furnace in which a temperature was raised to 1400° C. at a rate of 5°C./min. in nitrogen. A carbonized film obtained by the carbonization was sandwiched between graphite plates, and then subjected to graphitization with use of a graphitization furnace in which a temperature was raised to 2800° C. at a heating rate of in argon. Then, a resulting product was compressed at a pressure of 20 MPa with use of a single-plate press. This produced a graphite film (having a thickness of 25 μm).

### Comparative Example 5

A polyimide film and a graphite film were produced as in Comparative Example 2 except that the carbonization conditions in the production of the graphite film were changed as follows.

The polyimide film was cut into a 5 cm×5 cm piece. Then the piece was sandwiched between graphite plates, and then subjected to carbonization with use of an electric furnace in which a temperature was raised to 1400° C. at a rate of 5° C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 25 μm).

### Example 12

A polyimide film and a graphite film were produced as in Example 5 except that the carbonization conditions in the production of the graphite film were changed as follows.

The polyimide film was cut into a 5 cm×5 cm piece. Then the piece was sandwiched between graphite plates, and then subjected to carbonization with use of an electric furnace in which a temperature was raised to 1400° C. at a rate of 5° C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 18 μm).

### Example 13

A polyimide film and a graphite film were produced as in Example 6 except that the carbonization conditions in the production of the graphite film were changed as follows.

The polyimide film was cut into a 5 cm×5 cm piece. Then the piece was sandwiched between graphite plates, and then subjected to carbonization with use of an electric furnace in which a temperature was raised to 1400° C. at a rate of 5° C./min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 32 μm).

### Reference Example 1

A polyamic acid solution was synthesized by (i) adding 4,4′-oxydianiline (ODA) at a proportion of 75 mol %, paraphenylenediamine (PDA) at a proportion of 25 mol %, and pyromellitic dianhydride (PMDA) at a proportion of 100 mol %, to N,N-dimethylformamide (DMF) which is an organic solvent for polymerization and (ii) stirring a resulting product so as to polymerize the resulting product in so doing, the polyamic acid solution was synthesized so that a solid content concentration in the polyamic acid solution to be obtained would be 18.5% by mass.

Then, acetic anhydride and isoquinoline were added to the polyamic acid solution so that 1.0 equivalent of the acetic anhydride and 1.0 equivalent of the isoquinoline were added with respect to the equivalent of the amic acid. Then, a resulting product was cast onto an aluminum foil. Then, the resulting product was subjected to hot air drying in a range of 120±10° C. for 4 minutes. This produced a gel film (polyimide precursor film) which was self-supporting. This gel film was removed from the aluminum foil, and the four sides of the gel film were fixed to a frame.

This gel film was fired in stages (in a first heating furnace at 275° C., in a second heating furnace at 400° C., in a third heating furnace at 450° C., and in a far-infrared heating furnace at 460° C.) so that imidization of the gel film advanced. This produced a polyimide film having a thickness of 50 rim. In so doing, the heating loss rate was 0.07, and the thermal shrinkage rate was 0.06%.

The polyimide film thus prepared was cut into a 5 cm×5 cm piece. Then the piece was sandwiched between graphite plates, and then subjected to carbonization with use of an electric furnace in which a temperature eras raised to 1000° C. at a rate of 16.7° C./ min. in nitrogen. A carbonized film obtained by the carbonization was sandwiched between graphite plates, and then subjected to graphitization with use of a graphitization furnace in which a temperature was raised to 2800° C. at a heating rate of 1° C./min, in argon. Then, a resulting product was compressed at a pressure of 20 MPa with use of a single-plate press. This produced a graphite film (having a thickness of 25 μm).

### Reference Example 2

A polyimide film and a graphite film were produced as in Reference Example 1 except that the carbonization. conditions in the production of the graphite film were changed as follows.

The polyimide film was cut into a 5 cm×5 cm piece. Then the piece was sandwiched between graphite plates, and then subjected to carbonization with use of an electric furnace in which a temperature was raised to 1400° C. at a rate of 5° C./ min. in nitrogen. A carbonized film obtained by the carbonization was sandwiched between graphite plates, and then subjected to graphitization with use of a graphitization furnace in which a temperature was raised to 2800° C. at a heating rate of 1° C./min. in argon. Then, a resulting product was compressed at a pressure of 20 MPa with use of a single-plate press. This produced a graphite film (having a thickness of 25 μm).

Table 1 shows the results of Examples 1 through 9, Comparative Examples 1 through 3, and Reference Examples 1 and 2.

TABLE 1

| | | | | | | | | | | | | | Physical properties | |
|---|---|---|---|---|---|---|---|---|---|---|---|---|---|---|
| | | | | | | | | | Physical properties | | | Heating | of graphite film | |
| | | | | | | | | | of polyimide film | | | rate in | | Thermal |
| | | | | Temperature (° C.) of each furnace | | | | | | Heating | Thermal | carboniza- | | diffu- |
| | Monomer ratio | | | Belt | 1st | 2nd | 3rd | 4th | Thickness | loss rate | shrinkage | tion | | sivity |
| | PMDA | ODA | PDA | oven | furnace | furnace | furnace | furnace | (μm) | (%) | rate (%) | (° C./min.) | Appearance | (cm²/s) |
| Ex 1 | 100 | 75 | 25 | 120 | 250 | 300 | 340 | 400 (IR) | 50 | 0.24 | 0.58 | 25 | E | 8.5 |
| Ex 2 | 100 | 75 | 25 | 120 | 250 | 300 | 450 | — | 50 | 1.48 | 0.75 | 25 | E | 8.5 |
| Ex 3 | 100 | 75 | 25 | 120 | 250 | 300 | 340 | 350 (IR) | 50 | 3.09 | 0.9 | 25 | E | 8.6 |
| Ex 4 | 100 | 75 | 25 | 120 | 270 | 340 | 370 | 400 (IR) | 50 | 0.15 | 0.5 | 25 | G | 8.3 |
| CE 1 | 100 | 75 | 25 | 120 | 250 | 300 | 340 | 480 (IR) | 50 | 0.05 | 0.1 | 25 | U | 7.7 |
| CE 2 | 100 | 75 | 25 | 120 | 250 | 300 | 340 | 450 (IR) | 50 | 0.12 | 0.28 | 25 | U | 7.9 |
| Ex 5 | 100 | 75 | 25 | 120 | 250 | 300 | 340 | 350 (IR) | 38 | 2.42 | 0.83 | 25 | E | 8.8 |
| Ex 6 | 100 | 75 | 25 | 120 | 250 | 300 | 340 | 350 (IR) | 62 | 3.76 | 0.95 | 25 | E | 8.4 |
| Ex 7 | 100 | 100 | 0 | 120 | 250 | 300 | 340 | 350 (IR) | 50 | 2.66 | 1.05 | 5 | E | 8.5 |
| CE 3 | 100 | 100 | 0 | 120 | 250 | 300 | 340 | 480 (IR) | 50 | 0.05 | 0.2 | 5 | G | 7.9 |
| Ex 8 | 100 | 75 | 25 | 120 | 250 | 300 | 340 | 400 (IR) | 50 | 0.24 | 0.58 | 5 | G | 6.8 |
| Ex 9 | 100 | 75 | 25 | 120 | 250 | 300 | 450 | — | 50 | 1.48 | 0.75 | 5 | G | 7.2 |
| Ex 10 | 100 | 75 | 25 | 120 | 250 | 300 | 340 | 350 (IR) | 50 | 3.09 | 0.9 | 5 | G | 7.3 |
| Ex 11 | 100 | 75 | 25 | 120 | 270 | 340 | 370 | 400 (IR) | 50 | 0.15 | 0.5 | 5 | U | 6.6 |
| CE 4 | 100 | 75 | 25 | 120 | 250 | 300 | 340 | 480 (IR) | 50 | 0.05 | 0.1 | 5 | P | 5.8 |
| CE 5 | 100 | 75 | 25 | 120 | 250 | 300 | 340 | 450 (IR) | 50 | 0.12 | 0.28 | 5 | P | 5.9 |
| Ex 12 | 100 | 75 | 25 | 120 | 250 | 300 | 340 | 350 (IR) | 38 | 2.42 | 0.83 | 5 | E | 8 |
| Ex 13 | 100 | 75 | 25 | 120 | 250 | 300 | 340 | 350 (IR) | 62 | 3.76 | 0.95 | 5 | G | 6.9 |
| RE 1 | 100 | 75 | 25 | 120 | 275 | 400 | 450 | 460 (IR) | 50 | 0.07 | 0.05 | 16.7 | G | 8.5 |
| RE 2 | 100 | 75 | 25 | 120 | 275 | 400 | 450 | 460 (IR) | 50 | 0.07 | 0.05 | 5 | P | 6.3 |

1. A method of producing a graphite film, comprising the steps of:
preparing a polyimide film having a heating loss rate X of 0.13% to 10%, which heating loss rate X is represented by Formula (1) below; and
graphitizing the polyimide film by subjecting the polyimide film to a heat treatment,
Heating loss rate X=(b−a)/a Formula (1)
where (i) a represents a mass of the polyimide film after the polyimide film is heated at 400° C. for 15 minutes and (ii) b represents a mass of the polyimide film after the polyimide film is heated at 150° C. for 15 minutes.

2. A method of producing a graphite film, comprising the steps of:
preparing a polyimide film having a thermal shrinkage rate of not less than 0.30% after being heated at 400° C. for 15 minutes; and
graphitizing the polyimide film by subjecting the polyimide film to a heat treatment.

3. The method as set forth in claim 1, wherein
the polyimide film contains: a dianhydride containing a pyromellitic dianhydride; and diamine containing at least one of 4,4′-oxydianiline and paraphenylenediamine.

4. The method as set forth in claim 3, wherein:
the polyimide film contains 4,4′-oxydianiline and paraphenylenediamine in an amount of not less than 90% relative to an entirety of the diamine; and
a ratio between an amount of the 4,4′-oxydianiline and an amount of the paraphenylenediamine are contained is 100:0 to 70:30.

5. The method as set forth in claim 3, wherein:
the polyimide film contains 4,4′-oxydianiline and paraphenylenediamine in an amount of not less than 90% relative to an entirety of the diamine; and
a ratio between an amount of the 4,4′-oxydianiline and an amount of the paraphenylenediamine are contained is 100:0 to 80:20.

6. The method as set forth in claim 1, wherein:
the step of graphitizing the polyimide film includes the steps of
carbonizing the polyimide film so as to obtain a carbonized film and
further heating the carbonized film at a high temperature; and
a heating rate during the carbonizing is not more than 5° C./min.

7. The method as set forth in claim 2, wherein
the polyimide film contains: a dianhydride containing a pyromellitic dianhydride; and diamine containing at least one of 4,4′-oxydianiline and paraphenylenediamine.

8. The method as set forth in claim 7, wherein:
the polyimide film contains 4,4′-oxydianiline and paraphenylenediamine in an amount of not less than 90% relative to an entirety of the diamine; and
a ratio between an amount of the 4,4′-oxydianiline and an amount of the paraphenylenediamine are contained is 100:0 to 70:30.

9. The method as set forth in claim 7, wherein:
the polyimide film contains 4,4′-oxydianiline and paraphenylenediamine in an amount of not less than 90% relative to an entirety of the diamine; and
a ratio between an amount of the 4,4′-oxydianiline and an amount of the paraphenylenediamine are contained is 100:0 to 80:20.

10. The method as set forth in claim 2, wherein:
the step of graphitizing the polyimide film includes the steps of
carbonizing the polyimide film so as to obtain a carbonized film and
further heating the carbonized film at a high temperature; and
a heating rate during the carbonizing is not more than 5° C./min.
